(19) United States
(12) Patent Application Publication
(10) Pub. No.: US 2019/0019366 A1
(43) Pub. Date: Jan. 17, 2019

(54) SYSTEM AND METHOD OF DETERMINING BALLOTS OF VOTERS COLLECTED WITH THE AID OF ELECTRONIC BALLOTING

(71) Applicant: AO Kaspersky Lab, Moscow (RU)

(72) Inventors: Dmitry M. Chepel, Moscow (RU); Roman V. Aleshkin, Moscow (RU)

(21) Appl. No.: 15/785,479

(22) Filed: Oct. 17, 2017

(30) Foreign Application Priority Data
Jul. 17, 2017 (RU) 2017125330

(51) Int. Cl. G07C 13/00

(52) U.S. Cl. CPC G07C 13/00

(57) ABSTRACT

Disclosed are systems and methods for determining ballots of voters collected for a plurality of candidates using electronic balloting. For each election observer, a public key associated with a respective election observer for encrypting ballots of one or more voters and a private key associated with a respective election observer for decrypting the ballots of the one or more voters are created. Further, decentralized registers of records for keeping track of ballots cast and received by the respective election observers from the voters. Ballot are cast by voters using the respective public keys of election observers and signed by a digital signature for each voter. At the end of balloting, the modified decentralized registers of records are decrypted using the private keys and the number of ballots cast by the voters for each candidate is calculated.

### CROSS-REFERENCE TO RELATED APPLICATIONS

This application claims the benefit of priority under 35 U.S.C. 119(a)-(d) to a Russian Application No. 2017125330 filed on Jul. 17, 2017, which is incorporated by reference herein in its entirety.

### FIELD OF TECHNOLOGY

The present disclosure relates generally to the field of electronic balloting systems, more specifically, to systems and methods of determining ballots of voters collected with the aid of electronic balloting.

### BACKGROUND

The widespread use of various computing devices (personal computers, notebooks, tablets, smartphones, and so forth), the advent of available high-performance servers, the manifold increase in the traffic capacity of computer networks and the significant lowering of the price of network traffic for end users in recent years have provided a powerful impetus for the use by individual users and entire organizations of distributed data processing systems, where data is formed on certain computing devices, processed on others, and stored on yet other devices. Cloud services are becoming ever more popular, in which the personal computing devices of the users are often employed as mere terminals. For example, online banking, hotel reservation and transportation ticketing systems, and rating systems (producing reviews of movies, for example) may appear in such cloud services.

The aforementioned distributed data processing systems also include electronic balloting systems—systems in which a user may vote for a candidate (e.g., during elections) or post a rating review (e.g., for a film viewed, a book read, or merchandise purchased) by using their computer. The benefits offered by an electronic balloting system include the ease of voting (only requiring the user's computer with specialized software provided and access to a computer network, such as the Internet), efficiency (the user may vote at any time and in any place with access to the computer network), and vote count accuracy (all votes are counted and stored centrally, and the counting is done efficiently and automatically, ruling out human error). Electronic balloting systems are also able to handle the tasks of heightened security (decreasing election violations such as compelling early voting, ballot box stuffing, vote fraud, deliberate vote counting errors, and so forth) and reliability of voting results.

One may identify two main tasks which a system of electronic balloting should solve effectively: voter anonymization and protection against vote falsification. Voter anonymization refers to any technology making it possible to conceal the voter and the vote cast during all stages of the balloting. Voter anonymization assures the secrecy of the voting, so that over the entire course of the voting, in all its phases, starting from voter registration and ending with the counting of votes after the voting is finished, it is not possible to determine who each voter voted for. Protection against vote falsification can refer to a technology which can counteract various kinds of falsification, including: bribery, administrative pressure, or blackmailing of voters; counterfeiting of votes (such as ballot box stuffing when paper ballots are used, replacing one vote with another, and so on); unlawful interference with the work of the voting observers at the balloting stations; and deliberate mistakes in vote counts. Vote falsification can also include various kinds of “carousels”, which are methods of influencing the outcome of balloting involving bribery of a voter, consisting in giving the voter, before they enter the voting booth, a pre-filled ballot, which the voter needs to cast in the ballot box, taking away the new, empty ballot and exchanging it for money or other material valuables from the organizer of the “carousel”, who fills out the empty ballot and gives it to the next voter. Vote falsification also includes counterfeiting of voting records (for example, deliberately entering false data in the final balloting results); changing of voting results at those balloting stations where the “wrong” candidate won or where the results obtained at the balloting station may significantly affect the general results of the election, preventing the “right” candidate from achieving a victory; and so forth.

Although the known methods for electronic balloting systems may deal with the tasks of conducting an electronic balloting (i.e., recording and counting of the votes), they do not meet the needs of security (fewer violations during elections) or confidentiality of the votes (ensuring secrecy of voting so that during the entire voting process and at every stage thereof it would not be possible to determine who each voter voted for), and cannot deal with unauthorized modification of the results of the electronic balloting.

### SUMMARY

Thus, aspects of the present disclosure make it possible to solve the problem of determining the number of votes cast and gathered by electronic balloting, ensuring the confidentiality of the electronic balloting.

In one exemplary aspect, a method for voting in an election using electronic balloting comprises: receiving a unified balloting key associated with the election; obtaining a digital signature associated with a user based on voter identification information of the user; receiving user input selecting one of a plurality of candidates in the election; generating a ballot for the user comprising data specifying the selected candidate using the unified balloting key and the digital signature; and transmitting the generated ballot to a computing device associated with an election observer of the election.

In one exemplar aspect, generating the ballot comprises: encrypting a candidate identifier associated with the selected candidate encrypted using the unified balloting key, wherein the candidate identifier comprises a prime number.

In one exemplar aspect, generating the ballot comprises: the generating the ballot further comprises: signing the encrypted candidate identifier using the digital signature associated with the user.

In one exemplar aspect, generating the ballot comprises: the obtained digital signature comprises a public key provided to the election observer to verify the vote cast by the user and a private key used to sign the vote cast by the user.

In one exemplar aspect, generating the ballot comprises: generating the ballot for the user comprises: determining as a candidate identifier M associated with the selected candidate, wherein M is a prime number and has a value less than a random prime number q; selecting a session key α, such that 1<α<q−1; and generating the ballot as a set of number x and y by calculating x=g^{α} mod q and y=h^{α}M mod q, where g is a primitive root of q.

In one exemplar aspect, generating the ballot comprises: transmitting the generated ballot further comprises: receiving a list of network addresses of a plurality of computing devices associated with a plurality of election observers of the election; and transmitting the generated ballot to each of the plurality of computing devices associated with the plurality of election observers using the received list.

In one exemplar aspect, generating the ballot comprises: In one exemplar aspect, generating the ballot comprises: In one exemplar aspect, generating the ballot comprises: In one exemplar aspect, generating the ballot comprises: generating the ballot for the user comprises using at least one of: ElGamal encryption scheme, a Merkel-Hellman cryptosystem, and a Rabin cryptosystem.

In another exemplar aspect, a system for voting in an election using electronic balloting comprises: a processor configured to: receive a unified balloting key associated with the election; obtain a digital signature associated with a user based on voter identification information of the user; receive user input selecting one of a plurality of candidates in the election; generate a ballot for the user comprising data specifying the selected candidate using the unified balloting key and the digital signature; and transmit the generated ballot to a computing device associated with an election observer of the election.

Yet in another exemplar aspect, a non-transitory computer readable medium comprising computer executable instructions for voting in an election using electronic balloting, includes instructions for: receiving a unified balloting key associated with the election; obtaining a digital signature associated with a user based on voter identification information of the user; receiving user input selecting one of a plurality of candidates in the election; generating a ballot for the user comprising data specifying the selected candidate using the unified balloting key and the digital signature; and transmitting the generated ballot to a computing device associated with an election observer of the election.

According to another exemplary aspect, a computer-readable medium is provided comprising instructions that comprises computer executable instructions for performing any of the methods disclosed herein.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram depicting a system for determining the number of votes collected by means of electronic balloting according to an exemplary aspect.

FIG. 2 is a flowchart illustrating a method for determining the number of votes collected by means of electronic balloting according to an exemplary aspect.

FIG. 3 is a block diagram of a particular embodiment of the system for counting votes by means of electronic balloting according to an exemplary aspect.

FIG. 4 is a flowchart of a particular embodiment of the method of working of the balloting organizer according to an exemplary aspect.

FIG. 5 represents an example of a general-purpose computer system, a personal computer or a server according to an exemplary aspect.

### DETAILED DESCRIPTION

Exemplary aspects are described herein in the context of a system, method and computer program product for determining the number of votes collected by means of electronic balloting. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The following definitions and concepts will be used in describing variant embodiments of the present disclosure.

Voter anonymization refers to an algorithm ensuring voting secrecy (concealment of the voter's choice), so that throughout the voting process, in all of its stages, starting from voter registration to the final counting of the votes cast for each candidate participating in the balloting, at the end of the voting it is not possible to determine who the voter voted for.

Balloting refers to a group of actions aimed at identifying at least one candidate out of at least two candidates on the basis of data characterizing the choice of the voters.

Voter refers to a subject or group of subjects participating in the voting (including with the aid of computing devices) by making a choice of at least one of the candidates registered in that balloting, forming and transmitting the data characterizing that choice (hereinafter called the vote of the voter) to the balloting organizer for subsequent use of that data in calculating the results of the balloting carried out.

Observer refers to a subject or group of subjects monitoring the course of the balloting (including that with the use of computing devices) by checking the correctness of formation of the votes of the voters and the correctness of use of those votes of the voters when calculating the results of the balloting carried out.

Balloting organizer refers to a subject or group of subjects controlling the course of a balloting (including that with the use of computing devices) by establishing criteria for voting, the registration of candidates, observers, and voters, the organizing of their interaction with each other and the calculating of the results of the balloting.

Decentralized register of records refers to a data structure (such as a natural number) formulated according to definite rules on the basis of input data and the prior state of the decentralized register of records (previously formulated data). All of the states of the decentralized register of records form a distributed database, with which one works on the basis of transactions of the aforesaid input data, while in order for a transaction to be considered trustworthy (“confirmed”) its format and signatures need to be verified, and then entered into a special structure—the decentralized register of records.

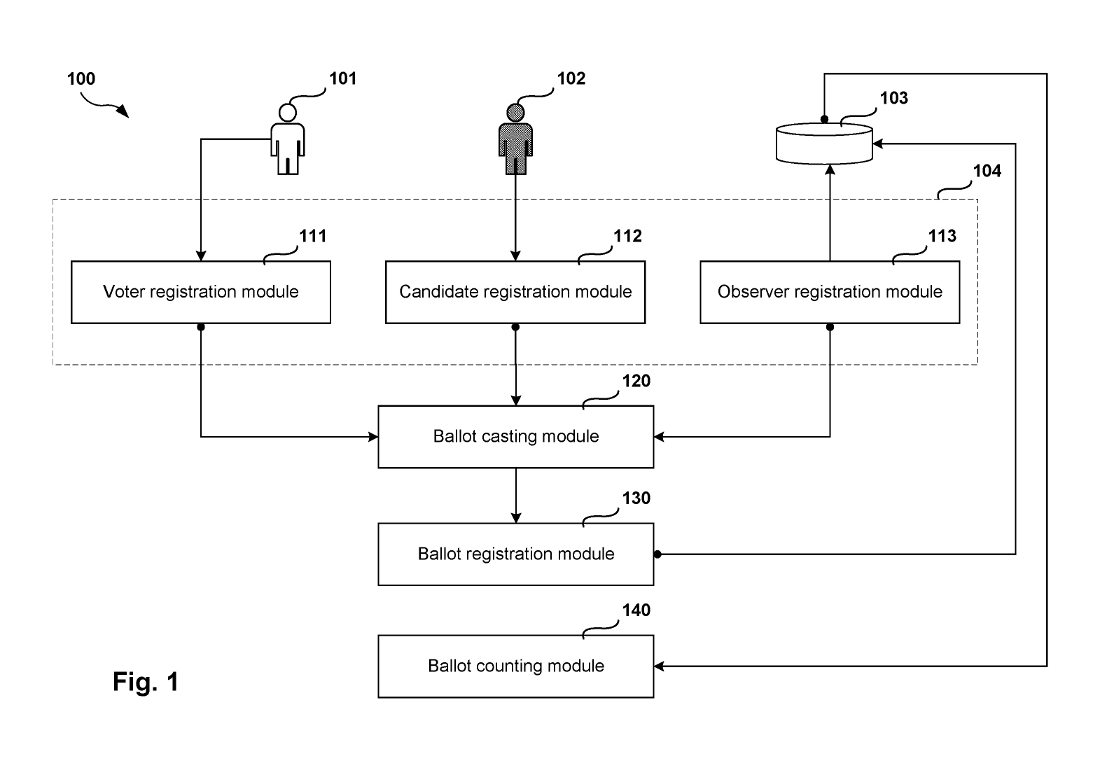

FIG. 1 is a block diagram depicting a system 100 for determining the number of votes collected by means of electronic balloting according to an aspect. The system 100 includes a voter 101, a candidate 102, an observer 103, a balloting organizer 104, a voter registration module 111, a candidate registration module 112, an observer registration module 113, a vote casting module 120, a ballot registration module 130, and a vote counting module 140.

In one variant embodiment of the system for concealment of the choice of the voter 101 made during a balloting process, the homomorphic properties of an ElGamal cryptosystem are used. The system is based on the difficulty of finding a discrete logarithm in a finite residue field. The principles of zero-knowledge proof are used to conceal the voter's 101 choice of candidate 102 and as proof that this concealed choice is valid. Thus: even the theoretical possibility of an invalid choice is ruled out; and the choice of the voter 101 is concealed during the stage of collection of the votes of the voters 101. Meanwhile, the validity of the choice of a candidate 102 comprises a choice meeting the balloting criteria established by the balloting organizer 104 (for example, only a previously registered voter 101 may vote, the choice may only be from the list of candidates 102, only one of all the candidates 102 may be chosen, and so on).

The voter 101 is the subject who is voting for at least one of the candidates 102 by transmitting a vote with the help of means available to the voter 101 or provided by the balloting organizer 104. In one variant embodiment of the system, the voter 101 participates in the balloting with the use of a computing device of the voter 101. This participation in the balloting may involves at least the following steps. The user or group of users register as a voter 101 with the help of the voter registration module 111 based on their identification data for participation in said balloting. The voter 101 directly participates in said balloting, which includes making a choice of at least one candidate 102, casting a ballot of the voter 101 based on data on that choice, and transmits the cast ballot of the voter 101 for subsequent use in calculating the results of the balloting conducted. When voting is concluded, the results of the balloting is calculated.

In yet another variant embodiment of the system, the computing device of the voter 101 is at least: a personal computer, a notebook, a tablet, a mobile device (such as a mobile telephone, smartphone, and so on), on which the software (for example, a third-party application or browser providing access to an online balloting service working on the server of the balloting organizer 104) is running, provided by the balloting organizer 104 (for example, downloaded and installed from the site of the balloting organizer 104).

For example, the citizen of a country, to participate in upcoming presidential elections (balloting), goes to the site of the official electoral commission, which is the balloting organizer 104, downloads and installs on their mobile telephone the specialized application “voteApp”. After this, from their mobile telephone with the aid of the application “voteApp” they register as voter 101, after which they receive on their mobile telephone all necessary information about the upcoming elections (including the list of candidates 102, the time when the elections will take place, the criteria of the upcoming elections, support service numbers, and so forth) and the data needed by the application “voteApp” for casting the vote of the voter 101 (the identifier of the voter 101, encryption keys, and so on) and transmitting the cast vote of the voter 101 for its subsequent use in calculating the results of the elections held (the addresses of the servers where the cast vote may be sent, data on the owners of those servers and the observers 103 who own or control the working of those servers, and so on). Directly during the elections, the voter 101 from their mobile telephone and using the application “voteApp” makes a choice of candidate 102. The data on the choice of the voter 101 (formulated by the application “voteApp” into the vote of the voter 101) is sent to the balloting organizer 104 (or to the observers 103, if such an option is supported). Prior to the end of the elections, the voter 101 may be presented the opportunity for another vote. For example, the voter 101 may select a different candidate 102, or cast a vote which will be used in place of a previously cast vote when calculating the results of the balloting carried out. Upon completion of the elections, information about the results of the elections (the name of the winner, the distribution of votes by candidate 102, the voting dynamics by region, by time, and so forth) will be sent to the mobile telephone of the voter 101.

The candidate 102 is the subject (or object) for whom (or for which) the voter 101 is voting, whose votes are used by the balloting organizer 104 to calculate the results of the balloting and verified by the observers 103.

In one variant embodiment of the system, the candidates 102 on the basis of their identification data are assigned identifiers (numbers) (for example, by the balloting organizer 104), and the voter 101 when casting a vote uses this identifier of the chosen candidate 102. For example, if balloting is being conducted for the office of president among Smith, Johnson and Williams, each candidate 102 for the office of president may be assigned an identifier (Smith: 31415, Johnson: 92653, Williams: 58979), which will be used afterwards for the casting and using of the votes of the voters 101 when calculating the results of the balloting carried out.

In one variant embodiment of the system, the registration of the candidate 102 with the help of the candidate registration module 112 may commence with the sending of the identification data of the candidate 102 by the voter 101 from the computing device of the voter 101. For example, a book publisher who is the balloting organizer 104 has announced a voting among the purchasers of its products for the best artistic production published in the past year. The voter 101 may be a person who has downloaded the application “bookVoteApp” onto their tablet from the site of the book publisher and registered as a voter 101. The voter 101 from their tablet and using bookVoteApp prior to the start of the voting sends to the balloting organizer 104 a list of titles of artistic productions which in the opinion of the voter 101 may take part as candidates 102 in the upcoming voting, the titles of the artistic productions playing the role of the identification data of those candidates 102. The balloting organizer 104 after receiving the aforementioned list from the voter 101 performs the necessary verifications to make sure that the artistic productions from the list received meet the requirements placed on the candidates 102, after which the artistic productions having been verified are registered as candidates 102 in the upcoming voting and are assigned candidate 102 identifiers.

An observer 103 (also referred to as an election observer) is a subject or group of subjects monitoring the course of the balloting (including with the use of computing devices programmed to track the course of the balloting by predetermined criteria established by the balloting organizer 104 and sent to the observers 103, on the basis of the data being formed in the course of the voting), which consists in verifying the correctness of the votes cast by the voters 101 and the correctness of the use of those votes of the voters 101 in calculating the results of the balloting carried out. For example, the observers 103 in the balloting to elect the president of a country may be the election headquarters of each of the candidates 102. Thus, the election headquarters may not only verify the correctness of use of the votes of the voters 101, cast on the basis of the choice of the voters 101 for a candidate 102 by the mentioned observers 103, but also the falsifiability of the elections themselves (i.e., the correctness of use of the votes of the voters 101 cast on the basis of the choice by the voters 101 of all other candidates 102).

In one variant embodiment of the system, data on the observers 103 after registration with the aid of the observer registration module 113 is sent to the voters 101. In some aspects, the data on the observers 103 may include a list of addresses of servers being used by the observers 103 to which the voters 101 can send their votes. In some aspects, the data on the observers 103 may include general information on the observers 103 (including which candidate 102 they are working for) on the basis of which the voters 101 may decide as to the choice of which observer 103 the votes for the candidates 102 will be sent.

The registration of the observers 103 may be done by the balloting organizer 104. The primary tasks in the registration of the observers 103 involve: verification of the computing device(s) of the observers 103 as to the possible use of the votes of the voters 101 (including a verification of the computing power, the fault resistance and the resistance to unauthorized access); and verification of the independence of the observers 103 (verification that the observer 103 together with other observers 103 will not exert influence on the course of the balloting), discovery of connections with other observers 103, accounts of possible unlawful activity in falsification of voting results, and so forth.

The balloting organizer 104 is the subject or group of subjects exercising control over the course of the balloting. This control may include with the use of computing device(s) programmed to carry out the balloting according to established criteria on the basis of predetermined or dynamically arriving input data, such as lists of voters 101, candidates 102, observers 103, anticipated results of the balloting, and so forth. To determine anticipated results of the balloting, previously calculated distributions of the votes of the voters 101 between the candidates 102 is used to assess the possibility of voting falsification in the case where the calculated results of a current balloting and previously calculated results differ significantly from each other. The ballot organizer 104 may determine the criteria of the balloting (for example, determining the start and end of the balloting), the registration of candidates 102, observers 103 and voters 101, the organization of their interaction with each other, the identification and elimination of errors arising in the course of the balloting, and the calculation of the results of the balloting.

In some aspects, the balloting organizer 104 may establish criteria for voter 101 registration. For example, the possibilities of the voters 101 (or the functionality of the computing devices of the voters 101) using, in the balloting being conducted by the balloting organizer 104, data on the candidates 102 and observers 103. The balloting organizer 104 may determine the list of candidates 102 from which the voter 101 may make a selection (different voters 101 possibly having different lists of candidates 102), and the list of observers 103 to whom the voter 101 may send the vote cast by the voter 101 (different voters 101 possibly having different lists of observers 103). The balloting organizer 104 may determine the number of candidates 102 which the voter 101 may select, and the individual voting time for each voter 101 or group of voters 101.

In some aspects, the balloting organizer 104 may further establish criteria for candidate 102 registration (for example, the number of candidates 102 taking part in the elections being organized); observer 103 registration (for example, the minimum requirements on performance, fault tolerance and resistance to unauthorized access to the computing device(s) provided by the observers 103 to keep track of the votes of the voters 101); and criteria for the balloting and calculating of the balloting results (for example, the start time and the duration of the balloting, the possibility of the voters 101 voting for several candidates 102). In some aspects, the balloting organizer 104 may establish criteria for the rules for the interaction between voters 101 and observers 103. For example, the balloting organizer 104 selecting servers from a list of servers provided by the observers 103 to which the voters 101 may send their ballots).

In one example scenario, a group of people are preparing to elect their chairman. In order to carry out the balloting, at first a balloting organizer 104 is chosen, who may be the most respected member of that group, chosen in collegial manner, or may be brought in from the outside to create an independent electoral process. Formed from the people comprising that group are: the voters 101 (who may be the entire group), the candidates 102 (who also may act in the capacity of a voter 101), and observers 103 (for example, each candidate 102 and the group of voters 101 supporting him may form an observer group 103).

Since the balloting organizer 104 may possess a computing device to conduct the balloting (depending among other things on the number and the geography of the voters 101, the duration of the voting process, the level of protection against unauthorized interference in the course of the balloting, and so on), often the observer 103 may be a third party enjoying a certain reputation (having a portfolio of successfully conducted elections, a high level of trust on the part of the voters 101 or the balloting organizer 104) and possessing the computing device(s). For example, on one end of the spectrum, for presidential elections of a country, the balloting organizer 104 might be the election commission formed on the basis of the election legislation, possessing computing device(s) provided by the government, and so forth. In another example, on the other end of the spectrum, for elections for the head of an institution, the balloting organizer 104 might be a third party (such as commercial or noncommercial firms, government services, etc.) brought in (either on commercial terms or on an unpaid basis), whose primary activity consists in the organizing and conducting of small elections (just as mailing services may be created independently or can make use of already existing mail services such as Gmail®).

The voter registration module 111 may run on the computing device of the balloting organizer 104 and is configured to create, for each voter 101, a digital signature of the voter 101, to be used in casting the ballot of the voter 101. The voter registration module 111 may be further configured to send the created digital signature of the voter 101 to the computer device of the voter 101.

In one variant embodiment of the system, the created digital signature of the voter 101 is a set of public and private keys to be used in an asymmetrical encryption system. In such an embodiment, the public key, which will be used to verify the votes cast by the voters 101, is sent by the voter registration module 111 to the computing device of the observers 103. And, the private key, which will be used to sign the vote cast by the voter 101, is sent by the voter registration module 111 to the computing device of the voter 101. As described in greater detail below, when a voter selects a candidate they wish to vote for, the data indicating the vote (e.g., including at least a candidate identifier) is encrypted with a unified balloting key, and the encrypted vote is then signed using the digital signature of the voter. When an observer receives the generated vote from the voter, the observer may use the digital signature to check whether this voter has already voted, whether this voter has the right to participate in the election, whether the voter is registered in the system, and whether it is a fake signature, etc.

In yet another variant embodiment of the system, at least one of the following algorithms is used to create the digital signature of the voter 101: the ElGamal scheme, the Schnorr scheme, the probabilistic Rabin signature algorithm, the probabilistic RSA-PSS scheme (RSA Signature Scheme with Appendix-Probabilistic Signature Scheme), and the DSA, ECDSA (Elliptic Curve Digital Signature Algorithm).

In yet another variant embodiment of the system, the voter registration module 111 carries out the collection and storage of data on the voters 101. The data on the voters 101 may be the contact data at which information can be exchanged between the voters 101, the observers 103 and the balloting organizer 104. The voter registration module 111 may also carry out the determination of the rights of the voters 101 for whom data was previously obtained to take part in the balloting being conducted by the balloting organizer 104. The rights of the voters 101 may include the right to change one's vote in the course of the balloting, to delegate one's vote to another voter 101, and to register a candidate 102 with the aid of the candidate registration module 112.

In yet another variant embodiment of the system, the voter registration module 111 when accessed by a user not yet registered as a voter 101 may be configured to carry out a verification as to whether that user can be a voter 101 for the balloting being organized. If so, a successful verification of the creation for each user of a voter 101 identifier.

For example, in order to take part in balloting being organized by a balloting organizer 104, a voter 101 may first send to that organizer their voter data (such as passport data, information on occupation, education, interests, and so on.) This voter data may be used to determine the voter 101 rights and make a decision as to which balloting the voter 101 may take part in, including among other things the contact data (such as an email address) where the balloting organizer may communicate with the voter 101 to send him the digital voter 101 signature created.

Several examples of how the voters 101 may be registered is as follows. In one scenario, a balloting is being organized to select the winner in a competition for “Man of the Year” at a Company A. First, the balloting organizer 104 notifies by email all employees of Company A as to the upcoming balloting and provides the address of a resource on the Internet where all employees wishing to take part in the balloting may register themselves. Then, the employees via a browser go to the indicated address, familiarize themselves with the conditions of the upcoming balloting and the candidates 102 and give their consent to take part in the mentioned balloting. After an employee has given consent to take part in the mentioned balloting, they are automatically registered as a voter 101, is assigned an identifier, and a digital voter 101 signature is created and sent to the voter 101 (for example, by email). After the company employee has been registered as a voter 101, they may also take part in the preliminary selection of candidates 102 in the “Man of the Year” competition, having presented their candidate 102 or themselves. Since the voter 101 has expressed a desire to take part in the upcoming balloting, they may receive information: as to the course of preparations for the balloting (for example, the appearance of new candidates 102) and the status of the mentioned balloting; as to the start of the balloting; as to the course of the balloting, the change in status of the course of the balloting, the withdrawal of candidates 102 or the need for another balloting; and on the completion of the balloting and on the results of the balloting.

In another scenario, a balloting is being organized to elect the president of the country, data on the citizenry may be already present at the election commission playing the part of the balloting organizer 104. Therefore, the citizens are already potential voters 101, and their data (passport data, residential addresses, etc.) is available to the election commission 104. As a result, the citizens may be sent their digital voter 101 signatures at once, as well as data describing the upcoming elections for president (e.g., when the balloting will take place, which candidates for president are taking part in the elections, the electronic addresses of the servers where a vote may be cast, and so on).

The candidate registration module 112 runs on the computing device of the balloting organizer 104 and may be configured to create, for each candidate 102, a candidate 102 identifier and send the created candidate 102 identifiers to the computing devices of the voters 101. In some aspects, the candidate 102 identifier may be a simple number.

In one variant embodiment of the system, the candidate registration module 112 is also configured to collect and store data on the candidates 102, present to the voter registration module 111 the candidate 102 identifiers and the data collected on the candidates 102 for subsequent presenting thereof to the voters 101.

In yet another variant embodiment of the system, a voter 101, or an initiative group may register their candidate 102, if the candidate 102, the voter 101, or the initiative group meet the criteria established by the balloting organizer 104. The transmittal of the necessary data for registration of a candidate 102 may be done from the computing device of the voter 101 using the specialized software provided to the voter 101 by the balloting organizer 104.

For example, for the election for president of the country a balloting organizer 104 is instituted, being an election commission. The balloting organizer processes the data on the proposed candidates 102 presented by the citizens, the initiative groups, and the parties. If the nominee meets the requirements for a candidate 102, set forth in the election legislation, or if no violations have been recorded upon nomination of the candidate 102, the nominee is confirmed as candidate 102 in the balloting being organized. The registered candidate 102 is assigned a candidate 102 identifier.

The observer registration module 113 may run on the computing device of the balloting organizer 104 and may be configured to create, for each observer 103, based on the identification data obtained about the observer 103 a public key to be used for encrypting the ballot of the voter 101 and a private key to be used for decrypting the ballot of the voter 101. The observer registration module 113 may be configured to also create, for each observer 103, based on the identification data obtained from the observer 103 a decentralized register of records which will be modified to take into account the ballots cast and received by the observer 103 from the voters 101. In some aspects, the observer registration module 113 may be configured to send the created decentralized registers of records to the computing devices of the observers 103, send the created private keys to the vote counting module 140, create on the basis of the created public keys of all the observers 103 a unified balloting key, and send the unified balloting key to the computing devices of the voters 101.

In one embodiment of the system, the observer registration module 113 is further configured to verify on the basis of the private keys of at least two observers 103 the unified balloting key created. Responsive to determining the result of the aforementioned verification is positive, the observer registration module 113 may send the unified balloting key created to the computing devices of the voters 101.

In yet another variant embodiment of the system, the public and private keys created are used in an ElGamal cryptosystem, the exchanging of Diffie-Hellman keys, and the Williams cryptosystem.

In yet another variant embodiment of the system, the unified balloting key created is verified (i.e., determine whether the private keys of the observers 103 and the unified balloting key have been created in keeping with the established rules and on the basis of the data presented by the observers 103) on the basis of the private keys for at least two observers 103 and if the result of the verification is positive it is presented to the voters 101 for the purpose of being used in the subsequent casting of a vote by the voter 101.

In yet another variant embodiment of the system, the observer registration module 113 may be further configured to collect and store data on the observers 103, and send the obtained data to the other observers 103 and the balloting organizer 104 to create equal conditions in the processing of the ballots of the voters 101 during the voting process.

In yet another variant embodiment of the system, the observer registration module 113 forms, for each observer 103, the public and private keys as follows. The observer registration module 113 generates a random prime number q∈Z is generated, where Z is the space of prime numbers. The observer registration module 113 selects an integer g, being the primitive root of q; and a random integer s=Z_{q} is selected, such that 1<s<q. The observer registration module 113 then computes h=g^{s} mod q, wherein the public key is the set (q, g, h), and the private key is the number s or the set (q, g, s).

For example, the observer 103 for participation in the balloting being organized by the balloting organizer 104 first sends to it the contact data where the balloting organizer 104 may send the ballots cast by the voters 101. For example, the observer 103 may send to the organizer 104 the addresses of the servers on which the decentralized register of records is being processed. The observer 103 for participation in the balloting being organized by the balloting organizer 104 may further send its identification data, which will be used afterwards for identification of the observer 103 in the system for counting the votes collected by means of electronic balloting.

In one variant embodiment of the system, the unified balloting key is created according to the following technique. In some aspects, each observer 103 may generate a certain polynomial using some set of random numbers Cⱼ. One number within the set of random numbers (C₀) is the private key generated as discussed above. The observer j creates a private key (that is, the private key is known only to themselves), as a result they have on their hands a polynomial Pⱼ(x) whose value for candidate X is the public key of the observer j. Based on the values of Pⱼ(x) for all observers, the observer j calculates a unified voting key. It is noted that each observer independently calculates the unified voting key, but as a result of the above described process, all the computed unified voting keys should coincide.

In one implementation, each observer 103 Aᵢ forms the polynomial Pᵢ (i.e., calculates the coefficients C_{(i,j)}) represented by Equation (1) below.

$${P}_{i} ( x ) = {C}_{( i , 0 )} + {\sum }_{j = 1}^{N} {C}_{( i , j )} \times {x}^{j} , \qquad ( 1 )$$

where N is the total number of observers 103; C_{(i,j)} are the coefficients of the polynomial, being random numbers calculated by the observer 103 Aᵢ; C_{(i,0)} is a coefficient of the polynomial, being the private key calculated by the observer 103 Aᵢ and used in the closed system of electronic balloting. For each observer 103 Aₖ, k∈(0, N], the value of the formed polynomial is calculated at x=k, as in Equation (2) below.

P_{(j,k)}=Pⱼ(k) (2)

All the observers 103 exchange among themselves the calculated values of the formed polynomials P_{(j,k)}, such that each observer 103 Aₖ becomes the owner of a set of values of the polynomials {Pⱼ(k)}, j∈(0, N]. Each observer 103 Aₖ on the basis of their calculated private key C_{(i,0)} and the set of values of the polynomial {Pⱼ(k)} calculates the common balloting key (i.e., unified balloting key), being the public key used in the closed system of electronic balloting.

The vote casting module 120 (also referred to herein as a ballot casting module) runs on the computing device of the voter 101 and may be configured to cast the ballot of the voter 101 based on data as to the choice of the voter 101, including encryption of the ballot being cast by the voter 101 with the unified balloting key. The vote casting module 120 may be further configured to send the ballot cast to the ballot registration module 130 of at least one observer 103. In some aspects, the data on the choice of the voter 101 is the identifier of at least one candidate 102.

In one aspect, the vote casting module 120 when casting the ballot of the voter 101 is additionally configured to perform, in succession: the encryption of the data on the choice of the voter 101 by the unified balloting key, and the signing of the encrypted data on the choice of the voter 101 with the digital voter 101 signature. In some aspects, for the encryption of the candidate 102 identifier one uses the ElGamal scheme, the Merkel-Hellman cryptosystem, and the Rabin cryptosystem.

In yet another variant embodiment of the system, before casting the ballot of the voter 101 there is a determination (for example, by querying the balloting organizer 104) as to whether the ballot cast by the voter 101 will be used afterwards during the counting of the votes of the voters 101. For example, the ballot cast by the voter 101 will not be counted if the current balloting for the voter 101 is a repeat balloting, and the voter 101 is not entitled to vote again. In another example, the ballot cast by the voter 101 will not be counted if the voter 101 has chosen a nonexistent candidate 102.

In yet another variant embodiment of the system, the casting of the ballot of the voter 101 is done by encrypting data M describing the choice of the voter 101 as follows. One determines M as the identifier of the candidate 102 chosen by the voter 101, and representing a prime number, where M<q (q being a random prime number chosen by the balloting organizer 104). One selects a session key—a random integer α, such that 1<α<q−1. One computes the numbers x=g^{α} mod q, y=h^{α}M mod q (where g is the primitive root of q). The obtained set (x, y) is the ballot cast by the voter 101, where the length of the cast ballot in the ElGamal scheme is twice as long as the candidate 102 identifier M.

In yet another variant embodiment of the system, after the ballot of the voter 101 has been cast, vote casting module 120 sends the ballot for subsequent counting to the ballot registration module 130, running on one of the servers used by the observers 103 or the balloting organizer 104. In one aspect, the choice of which server is made by the voter 101 themselves. For example, the voter 101 may choose the server of an observer 103 trusted by them, for example, the observer 103 of the candidate 102 for whom the voter 101 is voting. In another aspect, the choice of which server is made automatically, by the ballot casting module 120 (for example, a less busy server or a server with the fastest response).

In yet another variant embodiment of the system, the ballot casting module 120 can send the ballot cast by the voter 101 to all accessible ballot registration modules 130, wherein the ballot registration modules 130 themselves may provide to the ballot casting module 120 the list of servers where the ballot cast by the voter 101 can be sent.

For example, initially only one server might be available to the voter 101 (i.e., the ballot casting module 120 running on the computing device of the voter 101). The address of this server might have been previously specified in the software installed on the computing system of the voter 101 and configured for electronic balloting. This server may be the server of the balloting organizer 104. However, there are also another 10 observers 103 taking part in the balloting organization, each of which has access to at least one address of a server of one of the observers 103, as well as the balloting organizer 104, and all of them together with the balloting organizer 104 and all the observers 103 have access to the addresses of all the servers. When the ballot casting module 120 sends the ballot cast by the voter 101 to the balloting organizer 104, the latter in turn sends to the ballot casting module 120 the addresses known to the balloting organizer 104 of the servers of the observers 103 to which the ballot casting module 120 should likewise send the ballot cast by the voter 101. Upon sending the ballot cast by the voter 101 to said servers of the observers 103, the ballot casting module 120 also, as before, receives from them a list of addresses of servers, known to said observers 103, to which the ballot cast by the voter 101 also needs to be sent. This process may repeat until the ballot casting module 120 has sent the ballot cast by the voter 101 to all known servers (or substantially all) of the observers 103.

In yet another example, after the start of the balloting, the voter 101 has an opportunity by using their voter 101 device to select one of the candidates 102. After confirming the choice, the identifier of the selected candidate 102 is determined and encrypted by the unified balloting key obtained by the voter 101 on their voter 101 device from the balloting organizer 104 before the start of the balloting. The encrypted identifier of the candidate 102 is signed by the digital voter 101 signature, obtained from the balloting organizer after the registration of that voter 101. The data received constitutes the ballot cast, which is sent to the ballot registration module 130.

The ballot registration module 130 runs on the computing device of the observer 103 and may be configured to modify the decentralized register of records to take into account the obtained ballot of the voter 101, and send the mentioned decentralized register of records to the vote counting module 140 after the balloting is finished. In some aspects, ballot registration module 130 may modify the decentralized register of records according to a rule represented by Equation (3) below.

P=(P×V)mod q (3)

where P is the content of the decentralized register of records, representing a natural number, V is the vote cast by the voter, representing a natural number, and q is a predetermined coefficient limiting the size of the content of the decentralized register of records.

In one variant embodiment of the system, the ballot registration module 130 may be further configured to modify the decentralized register of records by taking into account the ballot cast by the voter 101 after successful verification of the authenticity of the ballot cast by the voter 101. The authenticity of the ballot cast by the voter 101 may be recognized in the event that the digital signature used in casting the ballot of the voter 101 corresponds to the digital signature created by the voter registration module 111, and the candidate 102 identifier used in casting the ballot of the voter 101 corresponds to the created candidate 102 identifier.

In yet another variant embodiment of the system, the ballot registration module 130 is configured for synchronous modification of all decentralized registers of records so that all ballots cast by the voters 101 take part in the modification of the decentralized register of records.

In yet another variant embodiment of the system, the authenticity of the ballot cast by the voter 101 is recognized in the event that the digital signature used in casting the ballot of the voter 101 corresponds to the digital signature created by the observer registration module 113, and the candidate 102 identifier used in casting the ballot of the voter 101 corresponds to the candidate 102 identifier created by the voter registration module 111.

In yet another variant embodiment of the system, the authenticity of the ballot cast by the voter 101 is verified as described below. In order to make a verification of the ballot cast by the voter 101 on the observer 103 side, the condition must be fulfilled by the relationships represented by Equations (4) below:

log_{g}x=logₕ(y×G₁),

log_{g}x=logₕ(y×Gₖ), (4)

where vₖ∈Z_{f} are the possible balloting variants (total of k variants), a balloting variant constituting a candidate 102 identifier (thus, there are a total of k candidates 102 taking part in the balloting), and Gₖ out of Z_{f} are the multiplicative inverses of each prime number vₖ, such that:

Gₖ=vₖ⁻¹ mod q (5)

On the voter 101 side, the ballot is cast. One selects the session encryption key α, the random number co, and also the set of random numbers r[k] and d[k]. One composes the ballot of the voter 101 as represented in Equation (6):

vote=((x,y),(a,b,d,r,m)₁ . . . (a,b,d,r,m)ₙ), (6)

being a set of numbers (in other words, a vector of dimension 2+4×n), such that the values of x and y are calculated based on the relationships below.

x=g^{α} (7)

y=h^{α}M (8)

And, in a cycle, each element vote is composed as follows. If the k-th element is equal to the choice of the voter 101, then:

aₖ=g^{w} mod q (9)

bₖ=h^{w} mod q (10)

c=hash(vote₀) (11)

where vote₀ is a vector of the ballots cast without accounting for d, r, m, and:

dₖ=c−Σᵢdᵢ (12)

rₖ=w−adₖ (13)

mₖ=Gₖ (14)

where mₖ is the element vote. Otherwise, if the k-th element is not equal to the choice of the voter 101, then the values of a, b, m may be determined as follows:

aₖ=(g^{r}^{ₖ})×(x^{d}^{ₖ}) (15)

bₖ=h^{r}^{ₖ}×(y×Gₖ)^{d}^{ₖ} (16)

mₖ=Gₖ (17)

where mₖ is the element vote.

On the observer 103 side, a verification is done for the ballot cast by the voter 101 and received from the voter 101. The verification may involve a verification of the fulfillment of the following identities, for all k:

Σᵢdᵢ≡hash(vote₀) (18)

aₖ≡(g^{r}^{ₖ})×(x^{d}^{ₖ}) (19)

bₖ≡h^{r}^{ₖ}×(y×mₖ)^{d}^{ₖ} (20)

In yet another variant embodiment of the system, the modification of the decentralized register of records taking into account the ballot cast by the voter 101 is calculated by the formula represented in Equation (21) below.

P=(P×V)mod q (21)

where P is the content of the decentralized register of records, representing a natural number; V is the vote cast by the voter, representing a natural number; and a is a predetermined coefficient limiting the size of the content of the decentralized register of records.

In yet another variant embodiment of the system, at least two decentralized registers of records are formed, and afterwards all decentralized registers of records are modified synchronously, such that all ballots cast by the voters 101 are included in the modification of the decentralized registers of records.

In yet another variant embodiment of the system, the ballot registration module 130 may run on the device of the balloting organizer 104. In this case, the balloting organizer 104 is also an observer 103 and for the voter 101, the means of casting the ballot of the voter 101, and also the other observers 103 the balloting organizer 104 will be formally identical in functionality to the observers 103.

In yet another variant embodiment of the system, after obtaining the ballot cast by the voter 101, the ballot registration module 130 running on the device of one observer 103 may send the received ballot cast by the voter 101 to the ballot registration module 130 running on the device of another observer 103, while the ballot registration module 130 themselves may provide to the ballot casting module 120 the list of servers where the ballot cast by the voter 101 may be sent.

In one exemplary scenario, ten observers 103 are participating in the balloting. Each observer 103 (i.e., the ballot registration module 130 running on the computing device of the observer 103) knows at least the address of the server of another observer 103, while all observers 103 together know the addresses of all servers of all observers 103 on which are running all of the ballot registration module 130. Responsive to receiving a ballot cast by a voter 101 from the ballot casting module 120, the ballot registration module 130 will in turn send the obtained ballot cast by the voter 101 to the other ballot registration module 130 at the servers with the known addresses. Upon sending the ballot cast by the voter 101 to the mentioned servers of the observers 103, the ballot registration module 130 receives from them a list of server addresses known to those observers 103 where the ballot cast by the voter 101 also needs to be sent. This repeats until such time as the ballot registration module 130 has sent the ballot cast by the voter 101 to all known servers of the observers 103.

The vote counting module 140 may run on the computing device of the balloting organizer 104 and may be configured to verify the authenticity of the decentralized registers of records and decrypt data on the ballots cast by the voters 101 in the decentralized register of records. The data on the ballots cast by the voters may be decrypted if the result of the aforementioned verification of the decentralized registers of records is positive and is performed using at least one private key previously created by the observer registration module 113. The vote counting module 140 may be configured to, based on the decrypted data on the ballots cast by the voters 101, calculate the number of ballots of the voters 101 cast for each of the candidates 102.

In one variant embodiment of the system, the vote counting module 140 may be further configured to verify the authenticity of the decentralized registers of records by means of a byte by byte comparison of at least two decentralized registers of records. In one variant embodiment of the system, the completion of the balloting occurs when at least one criterion predetermined by the balloting organizer 104 is fulfilled. Examples of the criterion may include the duration of the balloting has passed a predetermined value, the number of ballots has passed a predetermined value; or the number of unsuccessful verifications of the authenticity of the ballot cast by a voter 101 has passed a predetermined value. In yet another variant embodiment of the system, the calculation of the number of ballots in the event of using the ElGamal cryptosystem to calculate (factorialize) the number of ballots cast by the voters 101 employs the Shanks algorithm.

### Example: Vote Collection for Presidential Elections

The following disclosure presents an example working of the system for counting votes collected with the use of an electronic balloting system in the example of conducting presidential elections in Country X. An election commission has been created to handle organizational matters, as well as to prepare for and carry out these elections.

Three candidates are taking part in the presidential elections, representing 3 out of 5 political parties of the country, while the election commission has entered 15,000,000 voters on the election lists (representing the entire population of the country entitled to vote), and 5 observers 103 (one from each political party) have been registered with the election commission to monitor the course of the balloting. The election commission has established a period for holding the elections (1 Jan. 2017 10:00 a.m. to 2 Jan. 2017 8:00 p.m.), during which time the voters 101 can vote for one of the three candidates participating in the elections. At the end of this period, there will be a counting of the votes cast for each candidate, and the winner of the presidential elections will be determined.

The electronic elections consist of three main steps: (1) preparation for the start of the voting; (2) the actual voting itself, i.e., the collecting and counting of the votes of the voters 101; and (3) summing up the voting results.

### Step 1: Preparation for the Start of Voting

Prior to the start of voting (prior to the time established by the election commission: 1 Jan. 2017 10:00 a.m.) the following occurs: (1.1) the registration of candidates 102, during which data are created which will be used by the voters 101 during the holding of the balloting to cast the ballots of the voters 101; (1.2) the registration of observers 103, during which data are created which will be used during the holding of the balloting for the collecting and counting of the ballots of the voters 101; and (1.3) the registration of voters 101, during which information on the candidates 102 and the observers 103 is provided to the voters 101 from the election lists, which will be used by the voters 101 during the holding of the balloting to cast and transmit the ballots of the voters 101.

### 1.1: Registration of Candidates

For each candidate 102 participating in the elections, the election commission creates their own candidate 102 identifier, representing a natural number. For example, the following identifiers may be assigned:
candidate #1→31,
candidate #2→83,
candidate #3→101.

The candidate 102 identifier is created by random selection of a number in a predetermined range of values [2, 127]. The upper limit of the range of values (q=127, known as the base of the cryptosystem) is chosen in advance for reasons of mathematical expediency (i.e., a value is chosen for which, given the known number of candidates 102 and voters 101, the calculation of an unambiguous result after adding up the ballots of the voters 101 is guaranteed) and used in the mathematical computations in the course of the balloting.

### 1.2: Registration of Observers

One of the observers 103 is the election commission. The election commission 104 previously establishes that a minimum of 3 out of 5 observers 103 are needed for the decrypting of the ballots of the voters 101 collected in the balloting process. These values are chosen from the statistics of holding previous balloting, the identification data of the observers 103, and so forth, so that it is possible to complete the balloting (i.e., calculate the results of the balloting) even if some observers 103 may make mistakes in counting the ballots of the voters 101. For example, in the above-described example, 2 out of 5 observers may make mistakes in the counting of the ballots of the voters 101 (for example, falsifying the ballots of the voter 101). If a larger number of observers were chosen (such as 3 or 4) who might make mistakes, then the balloting may be falsified (the majority of observers might falsify the balloting according to a plan).

Each registered observer 103 previously creates a public and a private key to be used in an asymmetrical encryption system and sends to the election commission their individual observer 103 characteristics. Their individual observer 103 characteristics may include the created public key, as well as the address of their server, which will be used during the holding of the electronic balloting to exchange data with other observers 103 and voters 101 (for example, election-monitor.com:1200). Each registered observer 103 receives from the election commission or any other registered observer 103 the individual characteristics of the other registered observers 103, and also its own observer 103 identifier. Its own observer identifier may be, for example, a serial number under which the observer 103 is registered by the election commission or any other natural number chosen by the election commission 104 at random. Thus, after completing the registration of observers 103, each observer 103 has the individual characteristics of, at minimum, one other observer 103. Meanwhile, all the observers 103 together have the individual characteristics of all the registered observers 103, thereby making it possible to exchange data between observers 103. As such, the data transmitted from one observer 103 to another, via consecutive transmission from observer 103 to observer 103, is present at all registered observers 103.

Each registered observer 103 may formulate the polynomial represented by Equation (22).

$$P ( x ) = {C}_{0} + {\sum }_{i = 1}^{3} {C}_{i} \times {x}^{i} \qquad ( 22 )$$

where:
P(x)—is the formulated polynomial, the degree of the polynomial corresponding to the number of observers 103, chosen by the election commission, which are needed to decrypt the ballots of the voters 101 collected during the balloting process (in the present example, 5),
C₀—is the private key created, being a natural number;
Cᵢ—are the coefficients of the polynomial, being integers, the numbers being chosen so as to fulfill the condition represented by Equation (23) below:

P(x)∈(0,q),∀x,x∈ [symbol] ,x∈{xᵢ} (23)

where:
q—is the predetermined base of the cryptosystem, being a prime number, for example, q∈Mₚ, where Mₚ is the Mersenne number (a prime number of the kind 2ⁿ−1) (for the present example, q=127);
{xᵢ}—is the set of identifiers of all registered observers 103; for example, the set of identifiers may be as seen in Equation (24) below:

$${C}_{i} = \{ \begin{matrix}1232217802219824000 , \\ 578140416000 , \\ 596366064000 , \\ 99120672000\end{matrix} \} \qquad ( 24 )$$

where Cᵢ represents a set of 4 numbers, since 5 observers are participating in the balloting, for 4 of which we count the fifth (i) as Cᵢ.

For each of the 5 observers 103 (including itself), the observer computes the value of the formulated polynomial P(x) at point x∈{xᵢ} and sends the computed value to the corresponding observers 103. Thus, after completing the registration of the observers 103, each observer 103 has 5 values of polynomials created by the observers 103. On the basis of the values of the polynomial computed for all the observers 103, the observer registration module 113 computes the private key and sends it to all the observers 103, as in the example Equation (25) below.

Sc=g^{secret} mod q=g^{Σ}^{ᵢ}^{⁵}^{P(i)}mod q (25)

With the aid of all 5 available public keys, it creates the unified balloting key, as shown in Equation (26) below.

$$H = {\prod }_{i = 1}^{5} ( {g}^{{S}_{o} ( i )} mod q ) \qquad ( 26 )$$

where g is the predetermined primitive root; Sₒ(i) is the public key created by the observer 103 i, being a natural number; and q is the predetermined base of the cryptosystem.

In conclusion, on the basis of the previously obtained Sc, from the other values of the polynomials {P(x)}, the created public key H is checked for correctness, i.e., it will be possible afterwards to decrypt the collected ballots of the voters 101 with the obtained unified public key.

### 1.3: Voter Registration

Each voter 101 who intends to vote in the upcoming elections connects with the aid of specialized software to the online service of the election commission and/or any other observer 103 whom they trust. For example, members of the party Y will use the online service of the observer 103 from their party Y. From the online service, the voter 101 is sent data containing information on the candidates 102 (including their candidate 102 identifiers), the unified balloting key H created (computed); and the balloting characteristics, including the period for holding the balloting.

### Step 2: Voting

With the onset of the time established by the election commission for the start of voting, the voters 101 have an opportunity to cast voter 101 ballots and send them to their observers 103, while the observers 103 have an opportunity to keep track of the ballots of the voters 101 and exchange them. During the voting, there occurs: (2.1) a casting of ballots of the voters 101, (2.2) a verification of the ballots cast by the voters 101, and (2.3) a counting of the verified ballots of the voters 101.

### 2.1: Casting of Ballots of the Voters

The voter 101, using software running on their computing device (personal computer, smartphone, and so on), selects a candidate 102 for whom they wish to cast a vote. After the choice has been made, the ballot of the voter 101 is cast, for which the following steps may be performed. The ballot casting module 120 encrypts the candidate 102 identifier corresponding to the chosen candidate 102 with the unified balloting key H, obtained from one of the observers 103 in the voter 101 registration stage. The choice by the user 101 of the candidate 102 identifier for casting the ballot of the voter 101 is the casting of their voter 101 ballot for the chosen candidate 102. The ballot casting module 120 signs the encrypted candidate 102 identifier with the digital voter 101 signature. The ballot casting module 120 sends the ballot to the online service of the chosen observer 103.

### 2.2: Verification of the Cast Ballot

After one of the observers 103 receives the voter 101 ballot cast in step 2.1, they perform a verification of the received ballot to make sure that (i) the ballot belongs to a voter 101 who is entitled to participate in the mentioned elections; (ii) that voter 101 has not previously voted in those elections; (iii) the vote has been cast for a candidate 102 participating in those elections.

### 2.3 Counting of Verified Ballots:

After all the verifications performed in steps 2.1 and 2.2, the ballot cast by the inventor is counted by each observer 103, for which the ballot registration module 130 modifies the decentralized registers of records by taking account of the ballots cast by the voters 101 such that the decentralized register of records begins to contain the ballots cast by the voters 101. The actual modification of the decentralized registers of records is done so as to keep track of and not lose the information of which candidate 102 received the vote, yet entirely losing the information of who voted for which candidate 102. In a particular embodiment of the system, this may be represented in the form shown in Equation (27):

Pᵢ=(Pᵢ₋₁×Vᵢ)mod q (27)

where
Pᵢ is the content of the decentralized register of records after the i-th modification,
Vᵢ is the vote cast by the i-th voter 101,
q is a predetermined coefficient limiting the size of the content of the decentralized register of records.

In other words, the final decentralized register of records (after completion of the course of balloting) will look like the Equation (28):

$${P}_{i} = {P}_{0} \times {\prod }_{i = 1}^{n} ( {V}_{i} mod q ) \qquad ( 28 )$$

where
P₀—is the initial content of the decentralized register of records before making the modifications taking account of the ballots cast by the voters 101,
Vᵢ— is the vote cast by the i-th voter 101,
n—is the number of ballots cast by the voters 101 (in essence, the number of voters 101 having voted),
q is a predetermined coefficient limiting the size of the content of the decentralized register of records.

### 3: Summing Up the Results of the Voting:

After the period of time devoted by the election commission to the balloting has expired (or when all potential voters 101 have successfully voted), the collection of the ballots cast by the voters 101 is halted. The procedure of verification of the ballots of the voters 101 and the determination of the final results of the voting commences.

During the summing up of the results of the voting, there occurs: (3.1) a verification of the correctness of the collected ballots of the voters 101 for each observer 103, and (3.2) a determination of the number of votes collected for each candidate 102.

### 3.1: Verification of the Correctness of the Ballots Cast by the Voters for Each Candidate:

At this stage, a determination is made as to whether the ballots have been correctly collected by the different observers 103. For this, a comparison is done between the data gathered by each observer 103 containing the encrypted ballots of the voters 101. In the ideal situation, this data should match up; if this is not the case, it means that a certain observer 103 has incorrectly processed the ballots cast by the observers 103 and arriving at that observer (for example, certain votes were not counted or votes were replaced). The data of this observer 103 is ignored in the subsequent vote counting. If such observers 103 are in the majority, the elections are considered null and void, and the ballots of the voters 101 are not considered at all.

### 3.2: Determination of the Number of Votes Collected for Each Candidate:

At this stage, when it is already known that the elections have occurred successfully, the anonymized ballots of the voters 101 are extracted from the data received by one of the observers 103 (any one of the observers 103, since their data matches up) in the form shown in Equation (29):

$${V}_{k} = {\sum }_{i} {v}_{i} \qquad ( 29 )$$

where Vₖ—is the number of ballots cast for the k-th candidate, where the ballots of specific voters 101 vᵢ cannot be obtained directly from the data gathered by the observer 103 in the course of the balloting, since that information has been lost in the course of the data gathering. Thus, a closed (secret) system of electronic balloting is realized.

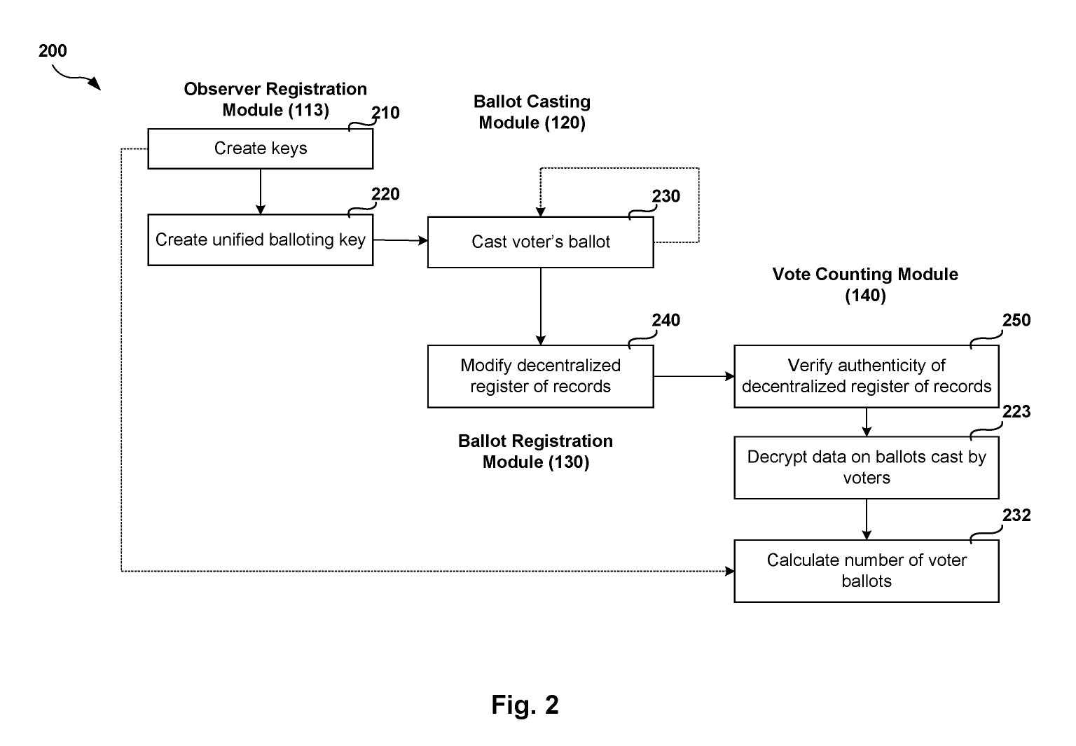

FIG. 2 is a flowchart illustrating a method 200 for determining the number of votes collected by means of electronic balloting according to an exemplary aspect.

The structural diagram of the method 200 for determining the number of ballots of voters collected by means of electronic balloting includes the following steps: step 210, in which the keys are created, step 220, in which the unified balloting key is created, step 230, in which the ballot of the voter is cast, step 240, in which the decentralized register of records is modified, step 250, in which the authenticity of the decentralized registers of records is verified, step 260, in which data on the ballots cast by the voters is decrypted, step 270, in which the number of ballots of the voters is calculated.

In step 210 the observer registration module 113 is used to create for each observer 103 on the basis of the identification data obtained from the observer 103: (i) a public key to be used for encrypting the ballot of the voter 101, and a private key to be used for decrypting the ballot of the voter 101; and (ii) a decentralized register of records, which will be modified to keep track of the ballots cast and received by the observer 103 from the voters 101.

In step 220 the observer registration module 113 is used to create a unified balloting key on the basis of the public keys of all observers 103 created in step 210.

In step 230 the ballot casting module 120 is used to cast a ballot for each voter 101 on the basis of data on the choice of the voter 101, including the encrypting of each voter 101 ballot being cast by the unified balloting key.

In step 240 the ballot registration module 130 is used to modify the decentralized register of records taking into account the ballot cast by the voter 101.

In step 250 the vote counting module 140 is used to verify the authenticity of the decentralized registers of records.

In step 260, if the verification performed during step 250 has a positive result, the vote counting module 140 is used to decrypt the decentralized registers of records using at least one private key created during step 210 of the data on the voter 101 ballots cast in the decentralized register of records.

In step 270, on the basis of the data decrypted in step 260 on the ballots cast, the vote counting module 140 is used to calculate the number of ballots cast by the voters 101 for each candidate 102.

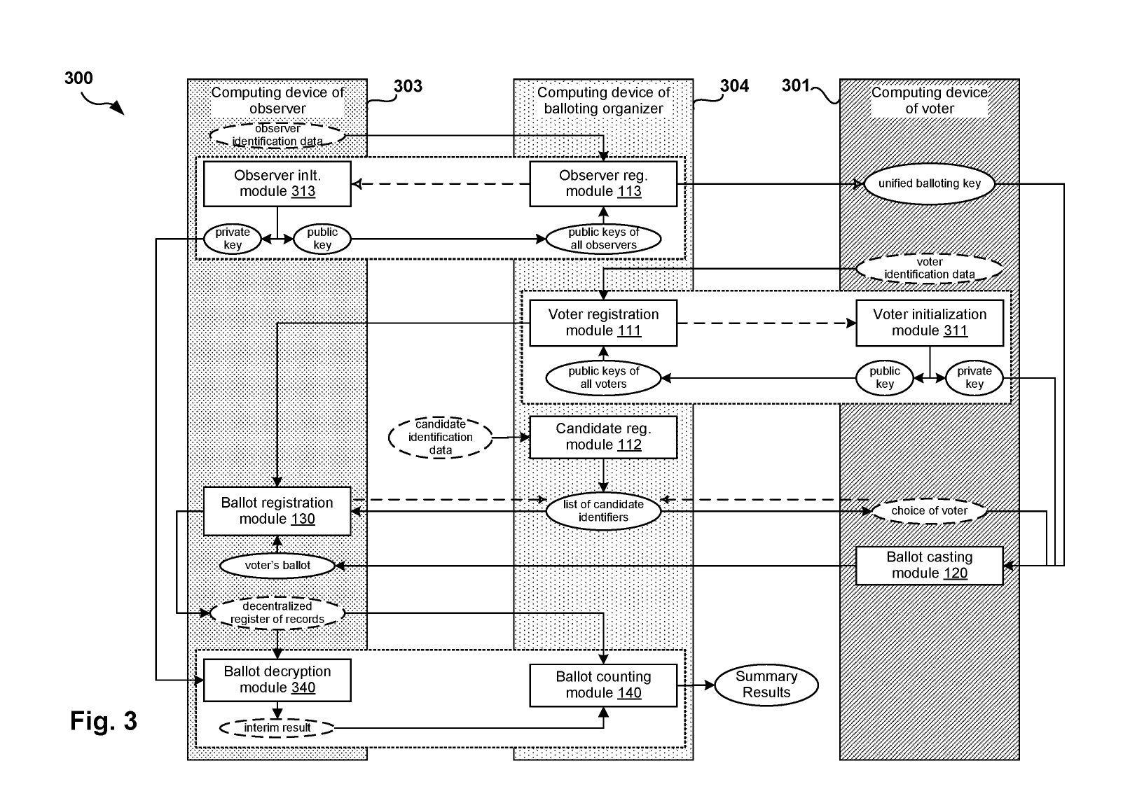

FIG. 3 is a block diagram of a particular embodiment of the system 300 for counting votes by means of electronic balloting according to an exemplary aspect.

The structural diagram of data relations with the system 300 for determining the number of ballots of voters collected with the aid of electronic balloting includes a computing device of a voter 301 having a voter initialization module 311 and the vote casting module 120, a computing device of an observer 303 having an observer initialization module 313, the ballot registration module 130 and ballot decryption module 340, a computing device of the balloting organizer 304 having the observer registration module 113, the voter registration module 111, the candidate registration module 112, and the vote counting module 140.

In one variant embodiment of the system, a threshold cryptosystem (n, k) is used, characterized in that, for the decryption of a ballot of a voter 101, encrypted with the use of public keys n of observers 103, it is sufficient to use private keys of at least k observers 103, i.e.

n>1,

1≤k<n,

where:
n—is the total number of observers 103,
k—is the minimum number of observers 103 needed to decrypt the ballots of the voters 101.

The voter initialization module 311, running on the computing device of the voter 301, and the voter registration module 111, running on the computing device of the balloting organizer 304, may be a client-server architecture, configured to register the voter 101 in the system for determining the number of ballots of the voters 101 collected with the aid of electronic balloting. The following steps are performed during the registration of the voter 101. The user who intends to take part as a voter 101 in the balloting announced by the election organizer 104 sends their identification data from their voter computing device 301 to the voter registration module 111. Then, the voter registration module 111 on the basis of the received identification data performs a verification of the user and, if this verification is successful, sends a request to the voter initialization module 311 to complete the initialization of the voter 101. The voter initialization module 311 creates the public and private encryption keys, sends the public key to the voter registration module 111, and keeps the private key on the computing device of the voter 301 for use as a digital signature when casting the ballot of the voter 101 in the voting process.

After the voter initialization module 311 has created the encryption keys and sent the public key to the voter registration module 111, the user is considered to be a registered voter 101. In the remainder of the voting process, the private key will be used as the identifier of the voter 101, i.e., as data uniquely determining the user during the voting organized by the balloting organizer 104.

In one variant embodiment of the system, the verification of the user consists in determining on the basis of the identification data of the user the right of the user to take part as a voter 101 in the balloting announced by the election organizer 104.

For example, even before organizing the actual balloting, the balloting organizer 104 already has access to a list of users who may register as voters 101. In the case of presidential elections, the election commission playing the role of the balloting organizer 104 has identification data of the citizens, such as the numbers of personal identity documents, from which the election commission can verify the citizens arriving at the voting stations or using remote balloting.

In yet another variant embodiment of the system, the verification of the user includes determining, on the basis of identification data of the user, including that describing the computing device of the voter 301, the absence of voters 101 who have been previously verified on the basis of similar identification data. The aforementioned action is aimed at avoiding situations where one and the same user may become registered from different voter computing devices 301 as different voters 101. For example, the very same user, having attempted to register as a voter 101 from different voter computing devices 301, will be determined as the very same user, so that they will be registered as a voter 101 only once on the first user computing device 301, and when trying to register from a second user computing device 301 they will be denied registration by the balloting organizer 104.

In yet another variant embodiment of the system, the user verification includes determining on the basis of the user identification data the technical possibility of participating with the use of the user's computing device 301 as a voter 101 in the balloting announced by the election organizer 104. This action is aimed at determining several factors relating to whether the voter 101, using the available computing devices, is able to participate in the balloting organized by the election organizer 104. In one aspect, this action may determine whether the computing resources are sufficient in the voter's computing device 301 to cast the ballot of the voter 101 in the voting process (for example, is there sufficient performance, main memory, and so forth. In another aspect, this action is aimed at determining whether the voter's computing device 301 meets the requirements of information security (e.g., is antivirus software running on said computing device, guaranteeing an absence of malware applications on the voter's computing device 301.) In one aspect, this action is further aimed at determining are the network resources enough to obtain data from the computing device of the balloting organizer 304 and to send data to the computing device of the observer 303 (e.g., is the traffic capacity and stability of the network channel to the computing devices of the balloting organizer 304 and observers 303 sufficient).

The observer initialization module 313, running on the computing device of the observer 303, and the observer registration module 113, running on the computing device of the balloting organizer 304, may be a client-server architecture, configured to register the observer 103 in the system for determining the number of ballots of the voters 101 collected with the aid of electronic balloting. The following steps are performed during the registration of the observer 103. The user who intends to take part as an observer 103 in the balloting announced by the election organizer 104 sends their identification data from their observer 303 computing device to the observer registration module 113. The observer registration module 113 on the basis of the received observer 103 identification data performs a verification of the user and, if this verification is successful, sends a request to the observer initialization module 313 to complete the initialization of the observer 103. The observer initialization module 313 creates the public and private keys, sends the public key to the observer registration module 113, and keeps the private key on the computing device of the observer 303 for use during the decryption of the ballots cast by the voters 101, which will be obtained by the observer 103 from the voters 101 in the balloting process. The observer registration module 113 verifies the correctness of the public and private key created by said user and in event of a successful verification the user becomes a registered observer 103.

In one variant embodiment of the system, the user verification includes determining on the basis of the identification data of the user the right of the user to participate as an observer 103 in the balloting announced by the election organizer 104.

For example, even before organizing the actual balloting, the balloting organizer 104 already has access to a list of users who may register as observers 103 (in the case of presidential elections, the election commission playing the role of the balloting organizer 104 has identification data of the citizens, such as the numbers of personal identity documents, from which the election commission can verify the users taking part in the balloting as observers 103, having access to the obtained ballots of the voters).

In yet another variant embodiment of the system, the verification of the user includes determining, on the basis of identification data of the user, including that describing the computing device of the observer 303, the absence of observers 103 who have been previously verified on the basis of similar identification data.

The aforementioned action is aimed at avoiding situations where one and the same user may become registered from different observer 303 computing devices as different observers 103. For example, the very same user, having attempted to register as an observer 103 from different observer 303 computing devices, will be determined as the very same user, so that they will be registered as an observer 103 only once on the first observer 303 computing device, and when trying to register from a second observer 303 computing device they will be denied registration by the balloting organizer 104.

In yet another variant embodiment of the system, the user verification includes determining on the basis of the user identification data the technical possibility of participating with the use of the observer's 303 computing device as an observer 103 in the balloting announced by the election organizer 104. This action is aimed at determining several factors for determining whether the observer 103 is “technically” able to participate in the balloting organized by the election organizer 104. In some aspects, determining the technical possibility of participation with the observer's computing devices includes determining whether the computing resources are sufficient in the computing device of the observer 303 to create the data used in casting the ballot of the voter 101 and register the ballot cast by the voter 101 in the balloting process (for example, is there sufficient performance, main memory, and so forth). In another aspect, determining the technical possibility of participation with the observer's computing devices includes determining does the computing device of the observer 303 meet the requirements of information security (for example, is antivirus software running on said computing device, guaranteeing an absence of malware applications on the computing device of the observer 303). In another aspect, determining the technical possibility of participation with the observer's computing devices further includes determining are the network resources enough to obtain data from the computing device of the balloting organizer 304 and the computing devices of the voters 301 (for example, is the traffic capacity and stability of the network channel to the computing devices of the balloting organizer 304 and voters 301 sufficient).

In yet another variant embodiment of the system, the initialization of observers 103 is done as follows. The observer initialization module 313 of each observer Pᵢ creates the polynomial Fᵢ(x), for which it assigns the coefficients fᵢⱼ of the polynomial F(x) of degree k−1, the set of created coefficients of the polynomial fᵢⱼ forming the private key of the observer 103 Pᵢ. The private key of the observer may be used as the basis for a common decryption key used to decrypt the (encrypted) ballots cast by voters. In one implementation, the observer initialization module 313 may calculate the polynomials according to Equation (30), provided below.

$${F}_{i} ( x ) = {\sum }_{j = 0}^{k - 1} {f}_{ij} \times {x}^{j} \qquad ( 30 )$$

i∈[1 . . . n],

k∈[1 . . . n),

fᵢⱼ∈

[symbol]

where:
Fᵢ(x)—is the polynomial created,
fᵢⱼ—are the coefficients of the polynomial Fᵢ(x),
fᵢ₀=sᵢ—is a free term of the polynomial Fᵢ(x),
n—is the total number of observers 103,
k—is the minimum number of observers 103 needed to decrypt the ballots of the voters 101;
   For each observer 103 Pⱼ (including the observer 103 itself Pᵢ) the observer initialization module 313 computes the value of the polynomial Fᵢ(j), sends the computed values of the polynomial Fᵢ(j) to the observer 103 Pⱼ, and computes on the basis of the free term of the polynomial Fᵢ(x) according to the formula in Equation (31) the value:

aᵢ=g^{s}^{ᵢ} (31)

where:
g—is the primitive root of q,
sᵢ—is the free term of the polynomial Fᵢ(x)
   and the computed value aᵢ forms the public key of the observer 103 Pᵢ. The observer initialization module 313 sends the formulated public key of the observer 103 Pᵢ to the observer registration module 113. In one variant embodiment of the system, the coefficients fᵢⱼ of the polynomial Fᵢ(x) can be assigned with the aid of a random number generator.

The observer registration module 113 computes the unified balloting key on the basis of the public keys of the observers 103 Pᵢ by the formula shown in Equation (32).

$$h = {\prod }_{i = 1}^{n} {a}_{i} = {\prod }_{i = 1}^{n} {g}^{{s}_{i}} \qquad ( 32 )$$

The observer registration module 113 computes a common decryption key on the basis of the free terms of the polynomials received Fᵢ(x). The observer registration module 113 verifies the correctness of the public and private keys of each observer 103 Pᵢ, for which it checks whether the observer initialization module 313 of the observer 103 Pᵢ has correctly computed the values of the polynomial Fᵢ(j). In other words, the observer registration module 113 checks whether a respective observer used for the formation of the public key of the observer 103 Pᵢ is the solution of the polynomial Fᵢ(x). This verification therefore determines whether the unified balloting key and the common decryption key have been correctly computed.

In some aspects, the observer registration module 113 may carry out the following steps in the verification. Firstly, the observer initialization module 313 of each observer 103 Pᵢ computes and sends to the observer registration module 113 the values shown in Equation (33)

Sᵢⱼ=g^{f}^{ᵢⱼ} (33)

where:
g—is the primitive root of q,
fᵢⱼ—are the coefficients of the polynomial Fᵢ(x), created by the observer initialization module 313 by the observer 103 Pᵢ,
   The observer registration module 113 verifies that the observer initialization module 313 of the observer 103 Pᵢ has indeed computed Fᵢ(j), by using the created coefficients of the polynomial fᵢⱼ for which it checks to make sure the equality shown in Equation (34) is fulfilled.

$${g}^{{f}_{ij}} = {\prod }_{l = 0}^{k - 1} {S}_{ij}^{{i}^{l}} \qquad ( 34 )$$

The observer registration module 113 verifies that the computed public key of the observer 103 Pᵢ corresponds to the coefficients of the polynomial fᵢⱼ received by the observer registration module 113 and created by the observer initialization module 313 of the observer 103 Pᵢ of the polynomial Fᵢ(x), and that these coefficients of the polynomial fᵢⱼ correspond to the computed unified balloting key, i.e.

$${\prod }_{i = 1}^{n} {g}^{{s}_{i}} = {\prod }_{i = 1}^{n} {S}_{i 0} = h \qquad ( 35 )$$

for which it checks to make sure that the equality is fulfilled

$${g}^{{s}_{i}} = {\prod }_{j = 1}^{n} {g}^{{f}_{ij}} = {\prod }_{j = 1}^{n} ( {\prod }_{l = 0}^{k - 1} {S}_{ij}^{{i}^{l}} ) \qquad ( 36 )$$

The candidate registration module 112, running on the computing device of the balloting organizer 304, may be configured for registration of the candidates 102. The registration of the candidates 102 is done as follows. The subject (such as a user) or the object intending to take part as a candidate 102 in the balloting announced by the election organizer 104 sends their identification data to the candidate registration module 112. The candidate registration module 112 on the basis of the received identification data of the candidate 102 performs a verification of the candidate 102 and, if this verification is successful, it assigns to the candidate 102 an identifier of the candidate 102 p, which is saved on the computing device of the balloting organizer 304, where the identifier of the candidate 102 is a prime number:

p∈ [symbol] ,

p>1. (37)

In one variant embodiment of the system, the verification of the candidate 102 includes a determination on the basis of the identification data of the candidate 102 of the right of the subject or object to take part as a candidate 102 in the balloting announced by the election organizer 104. The verification of the candidate 102 further includes a determination on the basis of the identification data of the candidate that there are no candidates 102 previously verified on the basis of similar identification data.

In yet another variant embodiment of the system, the identifier of the candidate 102 p is selected from a list of previously computed, nonrecurring prime numbers: (i) randomly, but so that each of the selected prime numbers is chosen for only one candidate 102; or (ii) in succession.

The ballot casting module 120, running on the computing device of the voter 301, casts the ballot of the voter 101 as follows. The voter 101 makes a choice of one of the candidates 102, the data on the choice of the voter 101 being the identifier of the chosen candidate 102 p. The ballot casting module 120 computes the session key α—a numerical value used during the encryption of the ballot of the voter 101, wherein the session key α is calculated again by the ballot casting means 120 each time a ballot is cast, so as to satisfy the condition:

α∈

[symbol]

α∈(1 . . . q−1) (38)

The ballot casting module 120 encrypts the identifier of the chosen candidate 102 p by the unified balloting key obtained from the observer registration module 113, by the formula represented in Equation (39):

vote={x,y}

x=g^{α}

y=h^{α}p (39)

where
g—is the primitive root of q,
h—is the unified encryption key obtained from the voter initialization module 311,
α—is the session key computed for the current ballot of the voter 101.
   The ballot casting module 120 signs the encrypted data with the private key obtained from the observer registration module 113. After the vote casting module 120 finishes the casting of the ballot, it sends the ballot cast to the ballot registration module 130.

In one variant embodiment of the system, the vote casting module 120 sends the ballot cast by the voter to the ballot registration means 130, running on the computing device of the observer 303 selected by the voter 101 of the observer 103. The selection of the observer 103 by the voter 101 to whose observer 303 computing device the data is sent from the user 301 computing device, is done on the basis of data provided to the voter 101 by the balloting organizer 104 (for example, the network addresses of the observer 303 computing devices).

The ballot registration module 130, running on the observer 303 computing device, registers the ballots of the voters 101 as follows. The received ballot cast by the voter 101 is encrypted with the public key of the observer 103. The decentralized register of records of the observer 103 who received the ballot cast by the voter 101 is modified to take into account the received ballot of the voter 101, the modification being done according to the rule shown in Equation (4):

P=(P×V)mod q (40)

where:
P—is the content of the decentralized register of records, representing a natural number,
V—is the vote cast by the voter, representing a natural number,
q is a predetermined coefficient limiting the size of the content of the decentralized register of records.

The ballot decryption module 340, running on the computing device of the observer 303, and the vote counting module 140, running on the computing device of the balloting organizer 304, are a client-server architecture, designed to calculate the final results of the balloting organized by the balloting organizer 104 with the aid of the system of determining the number of ballots of voters 101 collected with the aid of the electronic balloting. The following steps are performed during the decrypting of the ballots of the voters 101. The vote counting module 140 selects at least k of the n observers 103 taking part in the balloting organized by the balloting organizer 104. The ballot decryption module 340, running on the computing device 303 of the previously selected observer 103, uses the previously formed private key of the observer 103 to decrypt the decentralized register of records. The final result of the consecutive decrypting of the decentralized register of records by the ballot decryption module 340, running on the computing devices 303 of the selected k observers 103, will represent the product shown in Equation (41)

$$votes = {\prod }_{i = 1}^{n} {p}_{i}^{{v}_{i}} \qquad ( 41 )$$

where:
n—is the number of candidates 102 taking part in the balloting organized by the balloting organizer 104,
pᵢ—is the candidate 102 identifier of the i-th candidate 102,
vᵢ—is the number of ballots of the voters 101 cast for the i-th candidate 102.
   The vote counting module 140 factorizes the decrypted decentralized register of records on the basis of the identifiers of the candidates 102 taking part in the balloting organized by the balloting organizer 104;

In one variant embodiment of the system, the vote counting module 140 selects at least k out of the n observers 103: (i) randomly, or (ii) in dependence on the number of ballots cast by the voters 101, sent to the ballot registration means 130 running on the computing device 303 of a particular observer 103. For example, the vote counting module 140 selects k observers 103, to the ballot registration module 130 of which, running on the computing devices 303, the most ballots cast by the voters 101 have been sent.

In yet another variant embodiment of the system, for the factorization of the decrypted decentralized register of records the vote counting module 140 uses the Gelfond-Shanks algorithm (baby-step giant-step).

In yet another variant embodiment of the system, after computing the number of ballots of the voters 101 cast for each of the candidates 102, the vote counting module 140 performs a verification of the correctness of the factorization done for the decrypted decentralized register of records, for which it makes a comparison of the total number of voters 101 who have voted and the total number of ballots computed, i.e.

$${\sum }_{i = 1}^{n} {v}_{i} = {v}_{max} \qquad ( 42 )$$

where:
n—is the number of candidates 102 participating in the balloting organized by the balloting organizer 104,
vᵢ—is the number of ballots of the voters 101 cast for the i-th candidate 102,
vₘₐₓ—is the total number of voters 101 who have voted;
   In the event that the comparison shows a negative result, the results of the balloting are considered null and void.

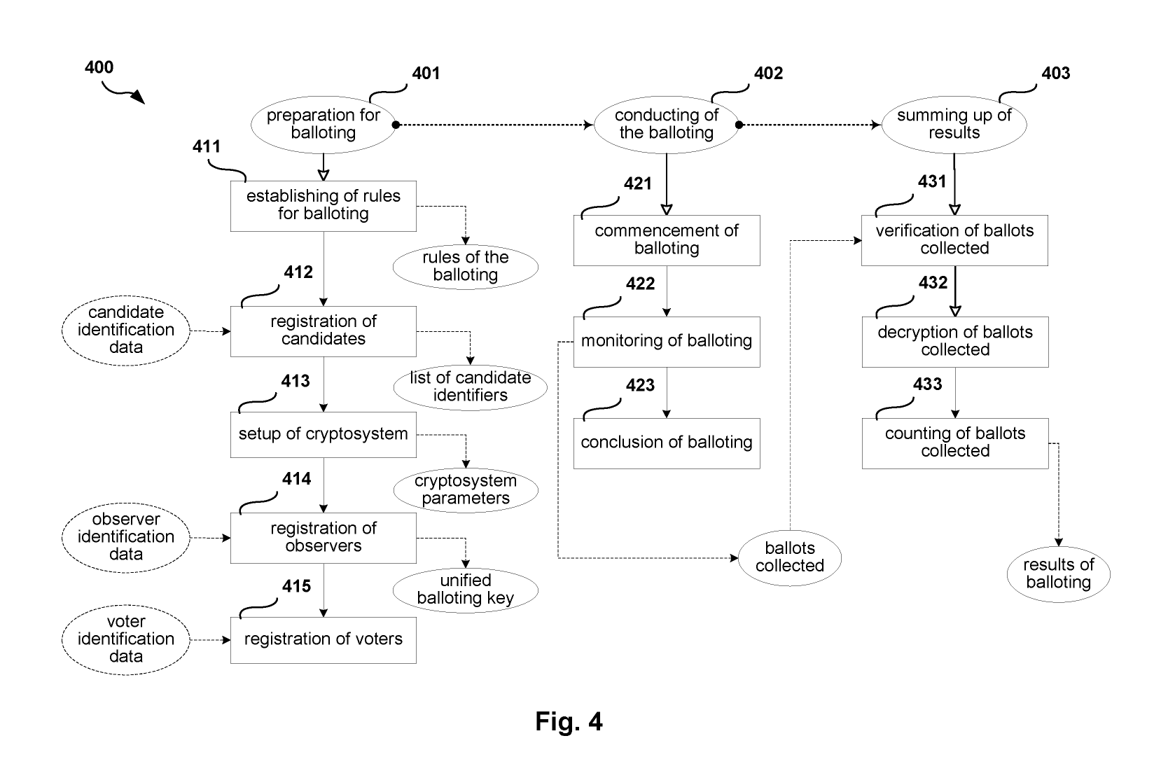

FIG. 4 is a flowchart of a particular embodiment of the method 400 of working of the balloting organizer according to an exemplary aspect.

The structural diagram of a particular embodiment of the method 400 of working of the balloting organizer includes the following steps: step 401, in which the preparations for the balloting take place, step 402, in which the balloting is carried out, step 403, in which the results are summed up, step 401, in turn containing step 411, in which the rules for conducting the balloting are established, step 412, in which the candidates are registered, step 413, in which the cryptosystem is set up, step 414, in which the observers are registered, step 415, in which the voters are registered, step 402, in turn containing step 421, in which the balloting process is commenced, step 422, in which the course of the balloting is monitored, step 423, in which the balloting process is concluded, step 403, which in turn contains step 431, in which the collected ballots are verified, step 432, in which the collected ballots are decrypted, and step 433, in which the collected ballots are counted.

In step 401, the balloting organizer 104 carries out preparations for the balloting: they assign the rules of the balloting, on the basis of which further preparations for the balloting are carried out, the balloting itself is carried out, and the ballots are counted after the balloting is finished, registration of candidates 102, setup of the cryptosystem, whose parameters will be used for the casting, storing and counting of the ballots of the voters 101, registration of observers 103 and registration of voters 101. The preparation for the balloting may be done precisely in the above-mentioned sequence—first establishing the rules for conducting the balloting, then on the basis of the established rules registering the candidates 102, then on the basis of the data on the candidates 102 setting up the cryptosystem, then on the basis of the parameters of the cryptosystem which has been set up registering the observers 103 and then on the basis of the data on the observers 103 registering the voters.

The rules for conducting the balloting are at least the rules limiting the minimum the number of observers 103 needed to count the ballots of the voters 101; the rule determining the maximum number of ballots of the voters 101 allowed for casting by a single voter 101; and the rule determining the conditions for the start and completion of the balloting. In some aspects, the condition for the start and completion of the balloting include at least the time for the start and completion of the balloting, the number of voters 101 after the registering of which the balloting commences, and the number of ballots of the voters 101, after the casting of which the balloting is completed.

In step 412, during the registration of the candidates 102, the balloting organizer 104 matches up each candidate 102 with a candidate 102 identifier, being a prime number:

pᵢ∈ [symbol] , (43)

where:
pᵢ—is the identifier of the i-th candidate 102,
[symbol] —is the space of prime numbers,
n—is the maximum number of candidates 102 as established by the rules
   where all the identifiers of the candidates 102 are different.

In step 413, the balloting organizer 104 sets up the cryptosystem, i.e., they compute the parameters of the cryptosystem on the basis of the rules established in step 411 for conducting the balloting and the candidate 102 identifiers assigned in step 412. The parameters of the cryptosystem are at least:
q—a random prime number (q∈ [symbol] ), such that q is larger than any given candidate 102 identifier,
g—the primitive root of q,
s—a random prime number (s∈ [symbol] _{q}),
   The number q is chosen such that the counting of ballots of the voters 101 after completion of the balloting produces an unambiguous result (i.e., a situation is not possible where the counting of ballots can be done in several ways resulting in several results differing from each other).

In step 414 the balloting organizer 104 registers the observers 103. During the registration of the observers 103, the balloting organizer 104 at least verifies the possibility of sending and receiving the ballots of the voters 101, as well as modifying the decentralized registers of records. The balloting organizer 104 may further verify the correctness of creation of the decentralized registers of records by the observers 103, verifies the correctness of creation of the public and private encryption keys by the observers 103, and create the unified balloting key on the basis of the parameters of the cryptosystem calculated in step 413.

In step 415 the balloting organizer 104 registers the voters 101. During the registration of the voters 101 the balloting organizer 104 at least verifies the possibility of casting the ballots of the voters 101, formulates the digital signature of the voter, and sends the unified balloting key created in step 414.

In step 402 the balloting organizer 104 carries out the balloting: they commence the balloting, monitor the course of the balloting and the rules of the balloting, and complete the course of the balloting.

In step 421 the balloting organizer 104 commences the course of the balloting, during which they at least notify the voters as to the possibility of casting the ballots of the voters 101, and notify the observers 103 as to the possibility of modifying the decentralized registers of records on the basis of the ballots cast by the voters.

In the event that a voter 101 tries to send a ballot cast by the voter 101 for the modification of the decentralized register of records of the observer 303, this ballot of the voter will not be counted or if upon completion of the course of the balloting it will be determined that said observer 303 made a mistake during the modification of its decentralized register of records and that decentralized register of records will not be considered during the counting of the collected ballots of the voters.

In step 422 the balloting organizer monitors the course of the balloting, during which at least the following occurs. The balloting organizer verifies the correctness of casting of ballots of the voters on the basis of the rules established in step 411 for conducting the balloting and the parameters of the cryptosystem calculated in step 413. They balloting organizer then verifies the correctness of the modifying of the decentralized registers of records of the observers 103 of the voters on the basis of the rules established in step 411 for conducting the balloting and the parameters of the cryptosystem calculated in step 413. Finally, the balloting organizer monitors the conditions for the completion of the balloting in accordance with the rules of the balloting established in step 411.

In step 423 the balloting organizer 104 completes the balloting process, during which at least the following occurs. The balloting organizer 104 notifies the voters that it is not possible to cast ballots of the voters 101. The balloting organizer 104 notifies the observers 103 that it is not possible to modify the decentralized registers of records on the basis of the ballots cast by the voters.

In the event that a voter 101 tries to send a ballot cast by the voter 101 for the modification of the decentralized register of records of the observer 303, this ballot of the voter will not be counted or if it is determined that said observer 303 made a mistake during the modification of its decentralized register of records and that decentralized register of records will not be considered during the counting of the collected ballots of the voters.

In step 403 the balloting organizer 104 sums up the results of the balloting. That is, the balloting organizer 104 verifies the ballots collected, decrypts the ballots collected, and finally counts the ballots collected.

In step 431 the balloting organizer 104 verifies the collected ballots of the voters 101, during which at least the following occurs. The balloting organizer 104 compares the decentralized registers of records of all observers 103. From the results of the verification of the decentralized registers of records, the balloting organizer 104 determines the observers 103 who have made mistakes (or deliberate falsifications) during the modification of their decentralized registers of records on the basis of the received ballots cast by the voters 101. From the results of the determination of observers 103 who have made mistakes, the balloting organizer 104 determines the observers 103 whose data will be used during step 432 in the decryption of the collected ballots of the voters. In the event that the number of observers 103 so determined is less than that established by the rules for conducting the balloting in step 411, the balloting organizer 104 declares the balloting to be null and void.

In step 432 the balloting organizer 104 performs the decryption on the basis of the parameters of the cryptosystem calculated in step 413 of the collected ballots of the voters 101 as modified on the basis of the obtained ballots cast by the voters 101. The decryption of the ballots of the voters 101 is done by modification of the decentralized register of records.

In step 433 the balloting organizer 104 counts up the collected ballots of the voters, and after obtaining the results of the balloting the balloting organizer 104 verifies whether they correspond to the rules for conducting the balloting that were established in step 411.

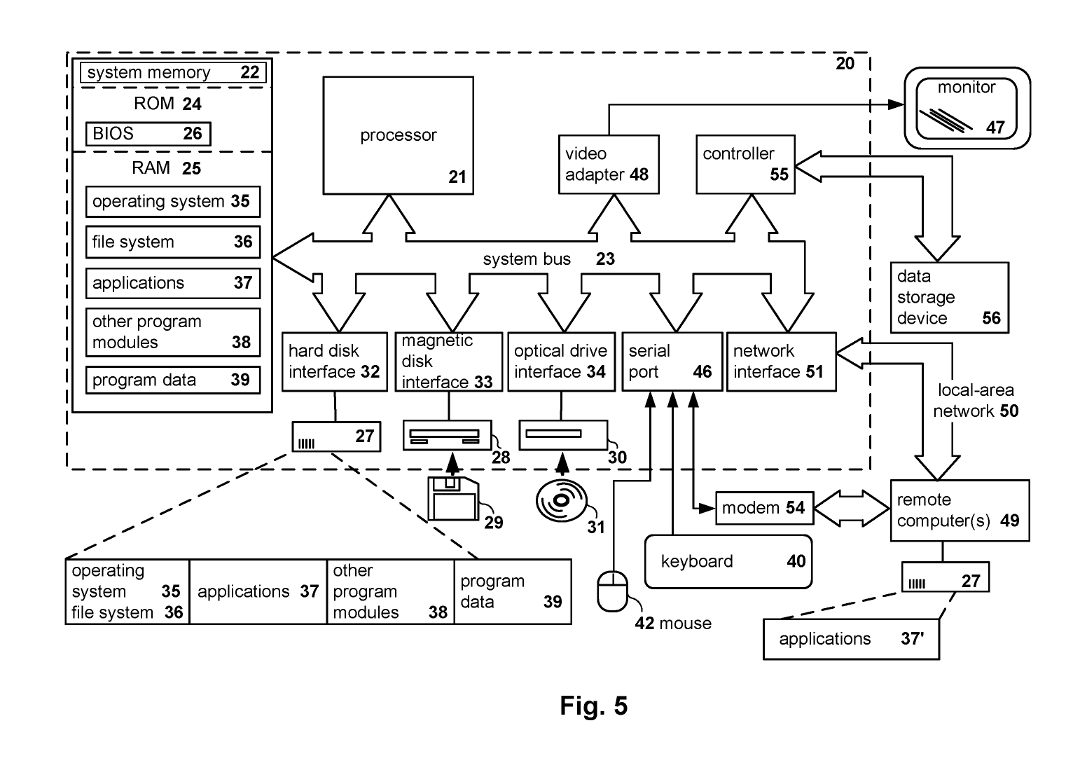

FIG. 5 is a block diagram illustrating a general-purpose computer system 20 on which aspects of systems and methods of determining ballots of voters collected using electronic balloting may be implemented in accordance with an exemplary aspect. It should be noted that the computer system 20 can correspond to the system 100, or the computing devices 301, 303, and 304, for example, described earlier.

As shown, the computer system 20 (which may be a personal computer or a server) includes a central processing unit 21, a system memory 22, and a system bus 23 connecting the various system components, including the memory associated with the central processing unit 21. As will be appreciated by those of ordinary skill in the art, the system bus 23 may comprise a bus memory or bus memory controller, a peripheral bus, and a local bus that is able to interact with any other bus architecture. The system memory may include permanent memory (ROM) 24 and random-access memory (RAM) 25. The basic input/output system (BIOS) 26 may store the basic procedures for transfer of information between elements of the computer system 20, such as those at the time of loading the operating system with the use of the ROM 24.

The computer system 20, may also comprise a hard disk 27 for reading and writing data, a magnetic disk drive 28 for reading and writing on removable magnetic disks 29, and an optical drive 30 for reading and writing removable optical disks 31, such as CD-ROM, DVD-ROM and other optical media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the computer system 20.

An exemplary aspect comprises a system that uses a hard disk 27, a removable magnetic disk 29 and a removable optical disk 31 connected to the system bus 23 via the controller 55. It will be understood by those of ordinary skill in the art that any type of media 56 that is able to store data in a form readable by a computer (solid state drives, flash memory cards, digital disks, random-access memory (RAM) and so on) may also be utilized.

The computer system 20 has a file system 36, in which the operating system 35, may be stored, as well as additional program applications 37, other program modules 38, and program data 39. A user of the computer system 20 may enter commands and information using keyboard 40, mouse 42, or any other input device known to those of ordinary skill in the art, such as, but not limited to, a microphone, joystick, game controller, scanner, etc. Such input devices typically plug into the computer system 20 through a serial port 46, which in turn is connected to the system bus, but those of ordinary skill in the art will appreciate that input devices may be also be connected in other ways, such as, without limitation, via a parallel port, a game port, or a universal serial bus (USB). A monitor 47 or other type of display device may also be connected to the system bus 23 across an interface, such as a video adapter 48. In addition to the monitor 47, the personal computer may be equipped with other peripheral output devices (not shown), such as loudspeakers, a printer, etc.

Computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes.

Network connections can form a local-area computer network (LAN) 50 and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the computer system 20 may employ a modem 54 or other modules well known to those of ordinary skill in the art that enable communications with a wide-area computer network such as the Internet. The modem 54, which may be an internal or external device, may be connected to the system bus 23 by a serial port 46. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a general purpose computer (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for voting in an election using electronic balloting, the method comprises:
receiving a unified balloting key associated with the election;
obtaining a digital signature associated with a user based on voter identification information of the user;
receiving user input selecting one of a plurality of candidates in the election;
generating a ballot for the user comprising data specifying the selected candidate using the unified balloting key and the digital signature; and
transmitting the generated ballot to a computing device associated with an election observer of the election.

2. The method of claim 1, wherein generating the ballot comprises:
encrypting a candidate identifier associated with the selected candidate encrypted using the unified balloting key, wherein the candidate identifier comprises a prime number.

3. The method of claim 2, wherein the generating the ballot further comprises:
signing the encrypted candidate identifier using the digital signature associated with the user.

4. The method of claim 1, wherein the obtained digital signature comprises a public key provided to the election observer to verify the vote cast by the user and a private key used to sign the vote cast by the user.

5. The method of claim 1, wherein generating the ballot for the user comprises:
determining as a candidate identifier M associated with the selected candidate, wherein M is a prime number and has a value less than a random prime number q;
selecting a session key α, such that 1<α<q−1; and
generating the ballot as a set of number x and y by calculating x=g^{α} mod q and y=h^{α}M mod q, where g is a primitive root of q.

6. The method of claim 1, wherein transmitting the generated ballot further comprises:
receiving a list of network addresses of a plurality of computing devices associated with a plurality of election observers of the election;
transmitting the generated ballot to each of the plurality of computing devices associated with the plurality of election observers using the received list.

7. The method of claim 1, wherein generating the ballot for the user comprises using at least one of: ElGamal encryption scheme, a Merkel-Hellman cryptosystem, and a Rabin cryptosystem.

8. A system for voting in an election using electronic balloting, the system comprises:
a processor configured to:
receive a unified balloting key associated with the election;
obtain a digital signature associated with a user based on voter identification information of the user;
receive user input selecting one of a plurality of candidates in the election;
generate a ballot for the user comprising data specifying the selected candidate using the unified balloting key and the digital signature; and
transmit the generated ballot to a computing device associated with an election observer of the election.

9. The system of claim 8, wherein generating the ballot comprises:
encrypting a candidate identifier associated with the selected candidate encrypted using the unified balloting key, wherein the candidate identifier comprises a prime number.

10. The system of claim 9, wherein the generating the ballot further comprises:
signing the encrypted candidate identifier using the digital signature associated with the user.

11. The system of claim 8, wherein the obtained digital signature comprises a public key provided to the election observer to verify the vote cast by the user and a private key used to sign the vote cast by the user.

12. The system of claim 8, wherein generating the ballot for the user comprises:
determining as a candidate identifier M associated with the selected candidate, wherein M is a prime number and has a value less than a random prime number q;
selecting a session key α, such that 1<α<q−1; and
generating the ballot as a set of number x and y by calculating x=g^{α} mod q and y=h^{α}M mod q, where g is a primitive root of q.

13. The system of claim 8, wherein transmitting the generated ballot further comprises:
receiving a list of network addresses of a plurality of computing devices associated with a plurality of election observers of the election;
transmitting the generated ballot to each of the plurality of computing devices associated with the plurality of election observers using the received list.

14. The system of claim 8, wherein generating the ballot for the user comprises using at least one of: ElGamal encryption scheme, a Merkel-Hellman cryptosystem, and a Rabin cryptosystem.

15. A non-transitory computer readable medium comprising computer executable instructions for voting in an election using electronic balloting, including instructions for:
receiving a unified balloting key associated with the election;
obtaining a digital signature associated with a user based on voter identification information of the user;
receiving user input selecting one of a plurality of candidates in the election;
generating a ballot for the user comprising data specifying the selected candidate using the unified balloting key and the digital signature; and
transmitting the generated ballot to a computing device associated with an election observer of the election.

16. The non-transitory computer readable medium of claim 15, wherein generating the ballot comprises:
encrypting a candidate identifier associated with the selected candidate encrypted using the unified balloting key, wherein the candidate identifier comprises a prime number.

17. The non-transitory computer readable medium of claim 16, wherein the generating the ballot further comprises:
signing the encrypted candidate identifier using the digital signature associated with the user.

18. The non-transitory computer readable medium of claim 15, wherein the obtained digital signature comprises a public key provided to the election observer to verify the vote cast by the user and a private key used to sign the vote cast by the user.

19. The non-transitory computer readable medium of claim 15, wherein generating the ballot for the user comprises:
determining as a candidate identifier M associated with the selected candidate, wherein M is a prime number and has a value less than a random prime number q;
selecting a session key α, such that 1<α<q−1; and
generating the ballot as a set of number x and y by calculating x=g^{α} mod q and y=h^{α}M mod q, where g is a primitive root of q.

20. The non-transitory computer readable medium of claim 15, wherein transmitting the generated ballot further comprises:
receiving a list of network addresses of a plurality of computing devices associated with a plurality of election observers of the election;
transmitting the generated ballot to each of the plurality of computing devices associated with the plurality of election observers using the received list.
